(19) United States
(12) Patent Application Publication
(10) Pub. No.: US 2026/0155577 A1
(43) Pub. Date: Jun. 4, 2026

(54) ADJUSTABLE ELECTROMAGNETIC ARRAY ELEMENT AND INTELLIGENT SURFACE

(71) Applicant: ZTE CORPORATION, Shenzhen (CN)

(72) Inventors: Suidao FU, Shenzhen (CN); Nan SHEN, Shenzhen (CN); Jianjun WU, Shenzhen (CN); Yindian MAO, Shenzhen (CN); Mingding LI, Shenzhen (CN)

(21) Appl. No.: 18/706,566

(22) PCT Filed: Nov. 7, 2022
(86) PCT No.: PCT/CN2022/130333

§ 371 Date: May 1, 2024

(30) Foreign Application Priority Data
Nov. 11, 2021 (CN) 202111331397.9

(51) Int. Cl. H01Q 15/00; H01Q 1/36; H01Q 3/46; H01Q 15/24; H01Q 19/02; H01Q 19/10

(52) U.S. Cl. CPC H01Q 15/002; H01Q 1/36; H01Q 3/46; H01Q 15/24; H01Q 19/02; H01Q 19/10

(57) ABSTRACT

Disclosed are an adjustable electromagnetic array element and an intelligent surface. The adjustable electromagnetic array element may include a reflective unit and a parasitic unit, the reflective unit comprises: at least one reflective metal sheet, and at least one adjustable element electrically connected to the reflective metal sheet and configured for adjusting an electromagnetic parameter of the adjustable electromagnetic array element according to an adjustment signal; and the parasitic unit is arranged at a periphery of the reflective metal sheet, and is coupled to the reflective metal sheet.

### CROSS-REFERENCE TO RELATED APPLICATION

This application is a national stage filing under 35 U.S.C. § 371 of international application number PCT/CN2022/130333, filed Nov. 7, 2022, which claims priority to Chinese patent application No. 202111331397.9, filed Nov. 11, 2021. The contents of these applications are incorporated herein by reference in their entirety.

### TECHNICAL FIELD

Embodiments of the present disclosure relate to the technical field of wireless communication, and more particularly, to an adjustable electromagnetic array element and an intelligent surface.

### BACKGROUND

The Reconfigurable Intelligent Surface (RIS), a key technology in wireless communications, has garnered significant interest in the industry. By manipulating the electrical parameters of electromagnetic array elements, an RIS can direct a specific beam orientation to either fill a coverage gap or enhance signal coverage in a target area. Reflective RISs can achieve signal coverage in a line-of-sight coverage hole of a base station, and therefore have great application potential. Reflective RISs can be divided into 1-bit and multi-bit RISs according to the number of reflected electromagnetic wave phase states, can be divided into single-polarization and multi-polarization RISs according to polarization characteristics of reflected waves, and can be divided into static and dynamic RISs according to whether the reflected beam can be switched by electric control.

Currently, RIS schemes generally have unsatisfactory performance. For example, RISs cannot meet the performance requirements of multi-bit multi-polarization schemes. Moreover, the effectiveness of RISs is currently hindered by factors such as the layout of array elements and the properties of the dielectric substrate, leading to high manufacturing costs and manufacturing challenges.

### SUMMARY

The following is a summary of the subject matter set forth in this description. This summary is not intended to limit the scope of protection of the claims.

Embodiments of the present disclosure provide an adjustable electromagnetic array element and an intelligent surface.

In accordance with a first aspect of the present disclosure, an embodiment provides an adjustable electromagnetic array element, including a reflective unit and a parasitic unit, the reflective unit includes: at least one reflective metal sheet, and at least one adjustable element electrically connected to the reflective metal sheet and configured for adjusting an electromagnetic parameter of the adjustable electromagnetic array element according to an adjustment signal; and the parasitic unit is arranged at a periphery of the reflective metal sheet, and is coupled to the reflective metal sheet.

In accordance with a second aspect of the present disclosure, an embodiment provides an intelligent surface, including a plurality of adjustable electromagnetic array elements in accordance with the first aspect.

### BRIEF DESCRIPTION OF DRAWINGS

To describe the technical schemes of the embodiments of the present disclosure clearly, the following briefly introduces the accompanying drawings required for describing the embodiments or existing technologies. Apparently, the accompanying drawings in the following description show only some of the embodiments of the present disclosure, and those having ordinary skills in the art may still derive other drawings from these accompanying drawings without creative efforts.

FIG. 1 is a schematic structural diagram of a reflective circuit layer of an adjustable electromagnetic array element according to an embodiment of the present disclosure;

FIG. 2 is a schematic structural diagram of a bias circuit layer of an adjustable electromagnetic array element according to an embodiment of the present disclosure;

FIG. 3 is a schematic diagram of a hierarchical structure of an adjustable electromagnetic array element according to an embodiment of the present disclosure;

FIG. 4 is a schematic structural diagram of a reflective circuit layer of an adjustable electromagnetic array element according to another embodiment of the present disclosure;

FIG. 5 is a schematic structural diagram of a bias circuit layer of an adjustable electromagnetic array element according to another embodiment of the present disclosure;

FIG. 6 is a schematic structural diagram of a conventional RIS according to another embodiment of the present disclosure;

FIG. 7 is a schematic structural diagram of a parasitic meta-surface according to another embodiment of the present disclosure;

FIG. 8 is a phase response waveform of an RIS according to another embodiment of the present disclosure;

FIG. 9 is a magnitude response waveform of an RIS according to another embodiment of the present disclosure;

FIG. 10 is a cross-polarization suppression waveform of an RIS according to another embodiment of the present disclosure;

FIG. 11 is a magnitude response waveform of multi-angle beam pointing of an RIS according to an embodiment of the present disclosure;

FIG. 12 is a magnitude response waveform of multi-angle beam pointing of an RIS according to another embodiment of the present disclosure;

FIG. 13 is a magnitude response waveform of multi-angle beam pointing of an RIS according to another embodiment of the present disclosure;

FIG. 14 is a schematic structural diagram of a reflective circuit layer of an adjustable electromagnetic array element according to another embodiment of the present disclosure;

FIG. 15 is a schematic structural diagram of a parasitic circuit layer of an adjustable electromagnetic array element according to another embodiment of the present disclosure;

FIG. 16 is a schematic structural front view of a parasitic meta-surface according to another embodiment of the present disclosure;

FIG. 17 is a schematic structural rear view of a parasitic meta-surface according to another embodiment of the present disclosure;

FIG. 18 is a schematic structural diagram of a reflective circuit layer of an adjustable electromagnetic array element according to another embodiment of the present disclosure; and

FIG. 19 is a schematic structural front view of a parasitic meta-surface according to another embodiment of the present disclosure.

### DETAILED DESCRIPTION

For purposes of illustration and not limitation, specific details such as particular system structures and techniques are set forth in the following description to provide a thorough understanding of the embodiments of the present disclosure. However, it should be appreciated by those having ordinary skills in the art that the embodiments of the present disclosure can be realized in other embodiments without these specific details. In some other cases, detailed description of well-known systems, apparatuses, circuits, and methods are omitted, to avoid unnecessary details which may interfere with the description of the embodiments of the present disclosure.

It is to be noted, although logical orders have been shown in the flowcharts, in some cases, the steps shown or described may be executed in an order different from the orders as shown in the flowcharts. The terms such as “first”, “second” and the like in the description, the claims, and the accompanying drawings are used to distinguish similar objects, and are not necessarily used to describe a specific sequence or a precedence order.

It should also be understood that reference to “an embodiment”, “one embodiment”, “some embodiments”, or the like described in the description of the embodiments of the present disclosure means that particular characteristics, structures, or features described in connection with the embodiment are included in one or more embodiments of the present disclosure. Therefore, phrases such as “in an embodiment,” “in one embodiment,” “in some embodiments,” and “in some other embodiments” in various places throughout this description are not necessarily referring to the same embodiment, but mean “one or more embodiments, not all embodiments,” unless otherwise particularly stated. The terms such as “include”, “comprise”, “have” and their variants all mean “including but not limited to”, unless otherwise particularly stated.

An intelligent surface is a two-dimensional planar array formed by a large number of passive electromagnetic array elements arranged according to a certain rule, and its thickness can be ignored. Because these specially designed electromagnetic array elements exhibit physical properties that materials in nature do not have, the two-dimensional array formed by these artificial electromagnetic array elements is also called a meta-surface. Each electromagnetic array element is formed by a metal or dielectric substrate of a particular shape, and is connected to an electronic element (adjustable element). The electronic element is controlled by an intelligent controller on a panel, and can realize independent adjustment of electromagnetic properties (e.g., an average permeability and an average dielectric constant) of electromagnetic array element. By adjusting the electromagnetic properties of the electromagnetic array element, an electromagnetic signal incident on the surface of the electromagnetic array element can be reflected or transmitted with different magnitudes, phases, polarization directions, etc. In this way, an imaginary line of sight path can be constructed between a base station and a user terminal device, thereby achieving an objective of intelligently adjusting the spatial electromagnetic environment. The intelligent controller in the intelligent surface sends an independent control instruction to each electromagnetic array element simultaneously, such that the magnitude, phase, or polarization direction of an electromagnetic wave incident on the surface of the electromagnetic array element changes correspondingly when reflected or transmitted. The electromagnetic waves reflected or transmitted by all the electromagnetic array elements are superimposed in space to produce a beamforming effect, and are finally received by a particular terminal device. The introduction of intelligent surfaces into a wireless communication system can realize the expansion and efficient utilization of spatial resources, thereby improving the channel capacity of the wireless communication system, improving the reliability and coverage of communication, reducing transmission power consumption and costs, and so on.

As one of the important potential technologies of future mobile communication (such as 6G), RIS has received much attention in the industry. By controlling electrical parameters of electromagnetic array elements, the RIS can form a specific beam orientation, to fill a coverage hole or enhance signal coverage in a region of interest. RISs can be divided into transmissive and reflective RISs according to functions. A transmissive RIS forms beam pointing in a direction of an incoming wave, and a reflective RIS forms beam pointing on the other side of the direction of the incoming wave. The reflective RIS can be hung on a wall surface of a building to achieve signal coverage in a line-of-sight coverage hole of a base station, and therefore have great application potential.

Reflective RISs can be divided into 1-bit and multi-bit RISs according to the number of reflected electromagnetic wave phase states, can be divided into single-polarization and multi-polarization RISs according to polarization characteristics of reflected waves, and can be divided into static and dynamic RISs according to whether the reflected beam can be switched by electric control. It is clear that dynamic reflective RISs supporting multi-bit and dual-polarization have the most comprehensive functions and the highest application value.

Currently, researches on RISs mostly focus on 1+1 (1-bit+single-polarization), 2+1 (2-bit+single-polarization), or 1+2 (1-bit+dual polarization) schemes. However, the performance of the existing RIS schemes is not satisfactory, which is found to be due to the following technical difficulties:
1) The multi-bit scheme requires more switching elements. This not only increases the complexity and power consumption of the control circuit, but also changes the electromagnetic characteristics of the electromagnetic array element, resulting in a mismatch between the RIS and spatial wave impedance, and reducing the reflection efficiency.
2) The multi-polarization scheme involves an inter-polarization coupling effect, which worsens the phase state of single polarization and affects the independent electrical tuning ability between different polarizations, leading to the loss of diversity gain brought by multi-polarization.
3) The electromagnetic characteristics of the meta-surface are closely related to the arrangement mode of electromagnetic array elements and the spacing between electromagnetic array elements. With the change of the RIS polarization mode and the array layout, the spatial sparseness of electromagnetic array elements changes constitutive parameters (equivalent permeability and equivalent dielectric constant) of the RIS, resulting in performance deterioration.
4) Similarly, the loss of the RIS is closely related to the dielectric substrate. Generally, a smaller thickness of the dielectric substrate and a lower dielectric constant indicates a lower reflection loss. For example, for an RIS in the sub-6G band, the low frequency requires a thicker material, which undoubtedly increases the costs and manufacturing difficulty.

Therefore, the effectiveness of RISs is currently hindered by factors such as the layout of array elements and the properties of the dielectric substrate, leading to high manufacturing costs and manufacturing challenges.

In view of the above, the embodiments of the present disclosure provide an adjustable electromagnetic array element and an intelligent surface. The adjustable electromagnetic array element includes a reflective unit 110 and a parasitic unit 120. The reflective unit 110 includes at least one reflective metal sheet and at least one adjustable element 112 electrically connected to the reflective metal sheet and configured for adjusting an electromagnetic parameter of the adjustable electromagnetic array element according to an adjustment signal. The parasitic unit 120 is arranged at a periphery of the reflective metal sheet, and is coupled to the reflective metal sheet. In the embodiment of the present disclosure, the parasitic unit 120 is arranged at the periphery of the reflective unit 110 of the adjustable electromagnetic array element to form a parasitic intelligent surface, and the constitutive parameters of the intelligent surface are changed using the coupling effect between the parasitic unit 120 and the electromagnetic array element, to reduce the reflection loss of the intelligent surface and improve the stability of the phase response of the intelligent surface, thereby overcoming the limitations on the performance of the intelligent surface caused by the array element layout and the dielectric substrate, and improving the reliability of the multi-bit multi-polarization RIS scheme.

For example, in some embodiments of the present disclosure, a multi-bit multi-polarization RIS technology based on a parasitic meta-surface is provided. A dynamic 2+2 (2-bit+dual-polarization) reflective RIS based on a grid-like parasitic meta-surface is designed using the parasitic meta-surface technology. The parasitic meta-surface adopts an orthogonal grid layout, which reduces the loss and suppresses the cross-polarized reflected waves, thereby achieving a ±45° dual-polarization 2-bit RIS with independent electrical tuning ability. This technology and design scheme solve many key technical difficulties in the design of dynamic multi-bit multi-polarization reflective RISs, and fill the gap for this type of products.

It should be noted that the term “RIS” in the following description refers to a dynamic reflective RIS, unless otherwise specified. This example is suitable for indoor and outdoor wireless communication, signal relay and other scenarios, and can be applied to, for example, base stations, small and micro base stations, electromagnetic reflective devices, and relay devices. The present disclosure can be used for enhancing coverage or filling a coverage hole of indoor/outdoor wireless signals, and can also be used for passive relay between stations. In the following description, the intelligent surface may be formed by a plurality of adjustable electromagnetic array elements. The plurality of adjustable electromagnetic array elements may be arranged in an M*N matrix or in other manners, which is not limited in the present disclosure. The parasitic unit 120 may be a periodic parasitic unit 120, i.e., the parasitic units 120 of the array elements of the intelligent surface macroscopically exhibit a periodic extension.

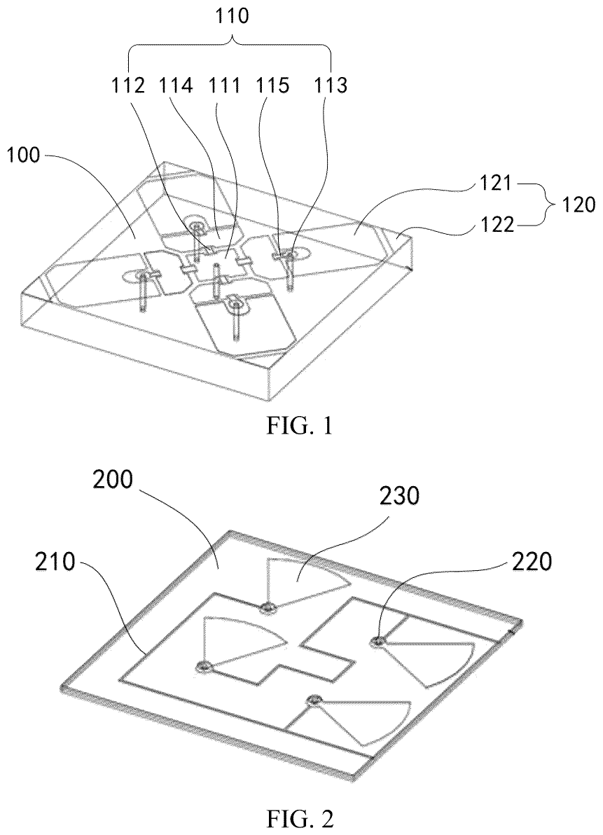

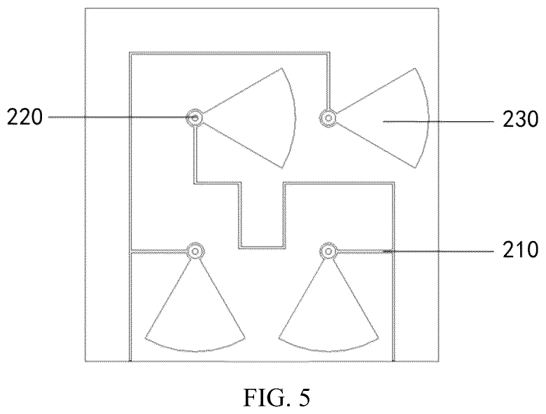

Referring to FIG. 1 and FIG. 4, an adjustable electromagnetic array element includes a reflective unit 110 and a parasitic unit 120.

The reflective unit 110 includes:
at least one reflective metal sheet, and
at least one adjustable element 112 electrically connected to the reflective metal sheet and configured for adjusting an electromagnetic parameter of the adjustable electromagnetic array element according to an adjustment signal.

The parasitic unit 120 is arranged at a periphery of the reflective metal sheet, and is coupled to the reflective metal sheet.

In some embodiments, the present disclosure proposes a multi-bit multi-polarization RIS technology based on a parasitic meta-surface. In this technology, a parasitic meta-surface is formed by nesting the periodic parasitic unit 120 around a conventional electromagnetic scattering unit, and a traveling wave current is constructed using the capacitive coupling effect between the reflective unit 110 and the periodic parasitic unit 120 to change constitutive parameters of the meta-surface, thereby changing the matching characteristics between the reflective meta-surface and spatial wave impedance, and improving the reflection efficiency and the phase response. This technology can reduce the influence on the electromagnetic response characteristics of the meta-surface due to variations in the size and spatial layout (spacing, direction, and position) of the electromagnetic array elements, switching elements and dielectric substrate, providing a basis for the realization of a low-cost, low-profile, high-stability multi-bit multi-polarization RIS.

In some embodiments, the present disclosure uses the meta-surface technology (where the meta-surface is a surface material formed by a periodic arrangement of periodic metal unit structures) to design a multi-bit multi-polarization reflective RIS based on a grid-like parasitic meta-surface. The periodic parasitic unit 120 in the grid-like parasitic meta-surface is arranged along a polarization direction of the reflective unit 110, to enhance the current in the polarization direction and suppress the cross-polarization current while improving the reflection efficiency and the phase response, thereby ensuring the independent electrical tuning ability between multi-polarized reflected waves. For example, in some embodiments, the reflective RIS can support ±45° dual polarization, 2-bit independent adjustment. Even if cross materials are used, the profile height (thickness) of the reflective surface can still be designed to only 0.05 wavelength, with the reflection loss at the center frequency being less than 3.4 dB, the suppression of cross-polarized reflected wave being more than 52 dB, and the operating bandwidth being up to 6%. All the indicators are better than those of existing RIS schemes. That is to say, compared with existing RIS scheme, the scheme of the present disclosure can achieve a smaller profile height (thickness) of the RIS, a lower loss, better suppression of the cross-polarized reflected wave, and a larger operating bandwidth, thereby improving the performance of the RIS while reducing the costs and the manufacturing difficulty. It can be understood that the effect of the present disclosure can be further improved by using a better material.

In some embodiments, the length and width dimensions of the adjustable electromagnetic array element may be designed according to requirements, for example, 0.2-1 center wavelength or 0.7-0.8 center wavelength, which is not limited in the present disclosure.

In some embodiments, the shape of the parasitic unit 120 is not limited, as long as the parasitic unit 120 can be coupled to the reflective unit 110 and provide an appropriate coupling strength.

In the embodiment of the present disclosure, the parasitic unit 120 is arranged at the periphery of the reflective unit 110 of the adjustable electromagnetic array element to form a parasitic intelligent surface, and the constitutive parameters of the intelligent surface are changed using the coupling effect between the parasitic unit 120 and the electromagnetic array element, to reduce the reflection loss of the intelligent surface and improve the stability of the phase response of the intelligent surface, thereby overcoming the limitations on the performance of the intelligent surface caused by the array element layout and the dielectric substrate, and improving the reliability of the multi-bit multi-polarization RIS scheme.

In some embodiments, the parasitic unit 120 is arranged in the same layer as the reflective unit 110 and coupled to the reflective unit 110; or
the parasitic unit 120 is arranged above the reflective unit 110 and coupled to the reflective unit 110; or
the parasitic unit 120 is arranged below the reflective unit 110 and coupled to the reflective unit 110.

In some embodiments, the parasitic intelligent surface technology of the present disclosure is to nest a periodic parasitic unit 120 around a reflective unit 110 of an electromagnetic array element in the related art. The parasitic unit 120 may be arranged in the same layer as, above, or below the reflective unit 110. An example where the adjustable electromagnetic array element has a multi-layer structure and the reflective element 110 is located in a reflective circuit layer 100 is described below.

In some embodiments, both the parasitic unit 120 and the reflective unit 110 are arranged in the reflective circuit layer 100. For example, the parasitic unit 120 and the reflective unit 110 are arranged on the same side of a dielectric plate, and a coupling gap is formed between the parasitic unit 120 and the reflective unit 110 in a horizontal direction to realize the coupling, or the parasitic unit 120 and the reflective unit 110 are coupled through an element (such as a resistor). The parasitic unit 120 and the reflective unit 110 may each include a metal sheet. The metal sheet may be bonded to the dielectric plate, or plated or coated on the dielectric plate, which is not limited in the present disclosure.

In some embodiments, the parasitic unit 120 is arranged above the reflective unit 110. For example, the parasitic unit 120 may be mounted above the reflective circuit layer 100 where the reflective unit 110 is located by a bracket or a dielectric plate. If the parasitic unit 120 is mounted above the reflective circuit layer 100 where the reflective unit 110 is located through the bracket, an air layer is formed between the parasitic unit 120 and the reflective unit 110. If the parasitic unit 120 is mounted above the reflective circuit layer 100 where the reflective unit 110 is located through the dielectric plate, the dielectric plate is arranged between the parasitic unit 120 and the reflective unit 110. A coupling gap is formed between the parasitic unit 120 and the reflective unit 110 in a vertical direction to realize the coupling; or the parasitic unit 120 and the reflective unit 110 are coupled through an element (such as a resistor).

In some embodiments, the parasitic unit 120 is arranged below the reflective unit 110. For example, the parasitic unit 120 may be arranged below the reflective circuit layer 100 where the reflective unit 110 is located, and a dielectric plate is arranged between the parasitic unit 120 and the reflective unit 110. A coupling gap is formed between the parasitic unit 120 and the reflective unit 110 in a vertical direction to realize the coupling; or the parasitic unit 120 and the reflective unit 110 are coupled through an element (such as a resistor).

In actual design, the parasitic unit 120 may be arranged in the same layer as, above, or below the reflective unit 110 according to requirements to achieve better reflected wave magnitude and phase response.

In some embodiments, a coupling gap is formed between the parasitic unit 120 and the reflective unit 110, such that the parasitic unit 120 and the reflective unit 110 are coupled through an electric field; or the parasitic unit 120 and the reflective unit 110 are coupled through an element.

In some embodiments, the coupling mode of the parasitic meta-surface provided in the present disclosure includes coupling of the parasitic unit 120 and the reflective unit 110 through an electric field, or coupling of the parasitic unit 120 and the reflective unit 110 through an element.

In some embodiments, the coupling of the parasitic unit 120 and the reflective unit 110 through an electric field means that a coupling gap is formed between the parasitic unit 120 and the reflective unit 110, i.e., the parasitic unit 120 is separated from the reflective unit 110 by the coupling gap. In terms of circuit connection, the parasitic unit 120 and the reflective unit 110 are disconnected for a direct current (DC); and for a high-frequency radio frequency (RF) signal, there is a coupling between the parasitic unit 120 and the reflective unit 110, i.e., an electric field coupling.

In some embodiments, coupling of the parasitic unit 120 and the reflective unit 110 through an element means that the parasitic unit 120 is connected to the reflective unit 110 through the element (such as a resistor), i.e., the element connects the parasitic unit 120 and the reflective unit 110 to form a DC circuit to realize coupling.

In some embodiments, the reflective unit 110 is arranged at a middle position in the adjustable electromagnetic array element, and the parasitic unit 120 is arranged at an outer periphery of the adjustable electromagnetic array element along the polarization direction of the reflective unit 110, and coupled to the reflective unit 110.

In some embodiments, the reflective unit 110 may be arranged on a surface of the adjustable electromagnetic array element, i.e., in the middle of the reflective circuit layer 100 to perform signal reflection.

In some embodiments, the parasitic unit 120 is arranged along the polarization direction of the reflective unit 110. For example, as shown in FIG. 1, for a cross-shaped dual-polarization reflective unit 110, the parasitic unit 120 is arranged extending in four directions of the cross-shaped reflective unit 110 to be coupled to the reflective unit 110.

In some embodiments, the reflective metal sheet includes:
a first metal sheet 111, configured for electrically connecting to ground; and
a bias voltage sheet 113, electrically connected to the first metal sheet 111 through the adjustable element 112 and configured for receiving an adjustment signal and transmit the adjustment signal to the adjustable element 112.

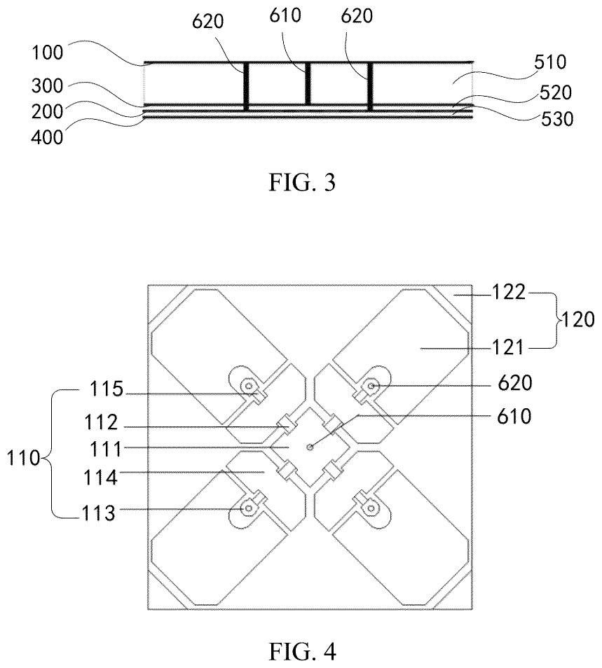

In some embodiments, referring to FIG. 3, the adjustable electromagnetic array element is a multi-layer structure including a reflective circuit layer 100, a floor layer, and a bias circuit layer 200. The reflective circuit layer 100 and the floor layer are isolated by a first dielectric plate 510, and the floor layer and the bias circuit layer 200 are isolated by a second dielectric plate 520. The first metal sheet 111 in the reflective circuit layer 100 is located at the center of the reflective unit 110. The first metal sheet 111 may be electrically connected to the floor layer through a metal via in the first dielectric plate 510 and thus grounded.

In some embodiments, the number of bias voltage sheets 113 corresponds to the number of adjustable elements 112. The bias voltage sheet 113 may be electrically connected to the bias circuit layer 200 through a metal via in the first dielectric plate 510 and a metal via in the second dielectric plate 520 in sequence to receive an adjustment signal from the bias circuit layer 200.

In some embodiments, the shape of the first metal sheet 111 is not limited. For example, the first metal sheet 111 may be a polygonal metal sheet or a circular metal sheet. The polygonal metal sheet may be a square metal sheet, a rectangular metal sheet, a trapezoidal metal sheet, etc., which is not limited in the present disclosure.

In some embodiments, the first metal sheet 111 is a polygonal metal sheet, and the parasitic unit 120 is correspondingly arranged along a side of the polygonal metal sheet, such that a strip-shaped coupling gap is formed between at least one side of the parasitic unit 120 and at least one side of the polygonal metal sheet;
or
the first metal sheet is a circular metal sheet, and the parasitic unit 120 is correspondingly arranged along a circumference of the circular metal sheet, such that an annular coupling gap is formed between an edge of the parasitic unit 120 and an edge of the polygonal metal sheet.

In some embodiments, the first metal sheet 111 is a polygonal metal sheet. A strip-shaped coupling gap is formed between one side of the parasitic unit 120 and one side of the first metal sheet 111. In some other embodiments, N strip-shaped coupling gaps may be formed between N sides of the parasitic unit 120 and corresponding N sides of the first metal sheet 111, which is not limited in the present disclosure.

In some embodiments, a second metal sheet 114 is further arranged between the first metal sheet 111 and the bias voltage sheet 113, the bias voltage sheet 113 is electrically connected to the second metal sheet 114, and the second metal sheet 114 is electrically connected to the first metal sheet 111 through the adjustable element 112.

The parasitic unit 120 is correspondingly arranged along a side of the second metal sheet 114, such that a coupling gap is formed between at least one side of the parasitic unit 120 and at least one side of the second metal sheet 114.

In some embodiments, the second metal sheet 114 is a polygonal metal sheet. A strip-shaped coupling gap is formed between one side of the parasitic unit 120 and one side of the second metal sheet 114. In some other embodiments, N strip-shaped coupling gaps may be formed between N sides of the parasitic unit 120 and corresponding N sides of the second metal sheet 114, which is not limited in the present disclosure.

In some embodiments, referring to FIG. 1 and FIG. 4, the first metal sheet 111 is an approximately square metal sheet as a whole, a groove structure is formed in the middle of each of four sides of the first metal sheet 111, and the groove structure is configured for accommodating one end of the adjustable element 112. Four second metal sheets 114 are arranged corresponding to the four sides of the square first metal sheet 111 and extend outward. The four second metal sheets 114 are each an elongated polygonal metal sheet. Corners at two ends of each of the second metal sheets 114 close to one side of the first metal sheet 111 are cut, such that the four second metal sheets 114 can be arranged around the first metal sheet 111. A groove configured for accommodating one end of the adjustable element 112 is formed on a long side of the second metal sheet 114 close to the first metal sheet 111. A groove configured for accommodating one end of an inductance element 115 is formed on a long side of the second metal sheet 114 distant from the first metal sheet 111. Four bias voltage sheets 113 are correspondingly arranged on outer sides of the four second metal sheets 114. Four parasitic units 120 are arranged along the outer sides of the four second metal sheets 114, i.e., the parasitic units 120 are arranged along the polarization direction of the reflective unit 110, forming a cross-shaped dual-polarization reflective electromagnetic array element. The bias voltage sheet 113 is electrically connected to the second metal sheet 114, and the second metal sheet 114 is electrically connected to the first metal sheet 111 through the adjustable element 112, such that the bias voltage sheet 113 can electrically transmit a control signal to the adjustable element 112.

In some embodiments, the reflective unit 110 further includes the inductance element 115, and the bias voltage sheet 113 is electrically connected to the second metal sheet 114 through the inductance element 115.

In some embodiments, RF currents of the first metal sheet 111 and the second metal sheet 114 may interfere with the control signal of the adjustable element 112. In this case, alternating current (AC) isolation can be realized by adding the inductance element 115 in the control signal circuit, to prevent the RF currents of the first metal sheet 111 and the second metal sheet 114 from flowing into the bias circuit layer 200, thereby protecting the control signal circuit and achieving accurate, effective, and reliable control of the control signal.

In some embodiments, in a case where the parasitic unit 120 and the reflective unit 110 are arranged in the same layer, the parasitic unit 120 is provided with a U-shaped groove configured for accommodating the bias voltage sheet 113 at a position corresponding to the bias voltage sheet 113.

In some embodiments, referring to FIG. 1 and FIG. 4, a U-shaped groove is etched on a side of a rectangular metal patch of the parasitic unit 120 facing the reflective unit 110, to prevent the formation of coupling between the parasitic unit 120 and the bias voltage sheet 113, thereby preventing energy from bypassing the inductance element 115 to flow into the bias circuit layer 200.

In some embodiments, the adjustable electromagnetic array element may be a single-polarization electromagnetic array element, and correspondingly the formed intelligent surface is a single-polarization intelligent surface. Alternatively, the adjustable electromagnetic array element may be a multi-polarization electromagnetic array element, and correspondingly the formed intelligent surface is a multi-polarization intelligent surface, which is not limited in the present disclosure.

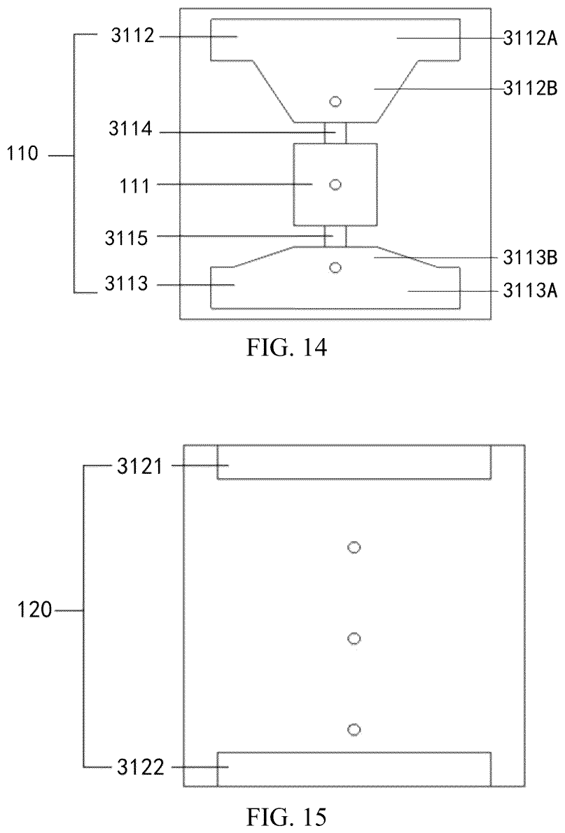

For example, the reflective unit 110 may be linear, and correspondingly, the adjustable electromagnetic array element is a single-polarization electromagnetic array element. Referring to FIG. 14 and FIG. 15, the reflective unit 110 includes a first metal sheet 111, a fourth metal sheet 3112, and a fifth metal sheet 3113. The first metal sheet 111 is a square metal sheet located in the middle of the reflective circuit layer 100. The fourth metal sheet 3112 includes a trapezoidal portion 3112B and a rectangular portion 3112A. A short side of the trapezoidal portion 3112B is arranged close to the first metal sheet 111, and a long side of the trapezoidal portion 3112B is arranged distant from the first metal sheet 111. The long side of the trapezoidal portion 3112B is connected to the rectangular portion 3112A. The fifth metal sheet 3113 is arranged opposite to the fourth metal sheet 3112. The fifth metal sheet 3113 includes a trapezoidal portion 3113B and a rectangular portion 3113A. A short side of the trapezoidal portion 3113B is arranged close to the first metal sheet 111, and a long side of the trapezoidal portion 3113B is arranged distant from the first metal sheet 111. The long side of the trapezoidal portion 3113B is connected to the rectangular portion 3113A. The fourth metal sheet 3112 and the fifth metal sheet 3113 are distributed on an upper side and a lower side of the first metal sheet 111, such that the reflective unit 110 is linear. The first metal sheet 111 and the fourth metal sheet 3112 are electrically connected through a first adjustable element 3114, and the first metal sheet 111 and the fifth metal sheet 3113 are electrically connected through a second adjustable element 3115.

For another example, the reflective unit 110 is cross-shaped, and correspondingly, the adjustable electromagnetic array element is a dual-polarization electromagnetic array element. Referring to FIG. 1 or FIG. 4, the reflective circuit layer 100 is a cross-shaped reflector formed by metal patches and includes a reflective unit 110 and a parasitic unit 120. As shown in FIG. 4, the reflective unit 110 is cross-shaped and includes a first metal sheet 111 of an approximately square shape at the center, an adjustable element 112, four second metal sheets 114, an inductance element 115, and a bias voltage sheet 113 from inside to outside, forming a ±45° dual-polarization electromagnetic unit.

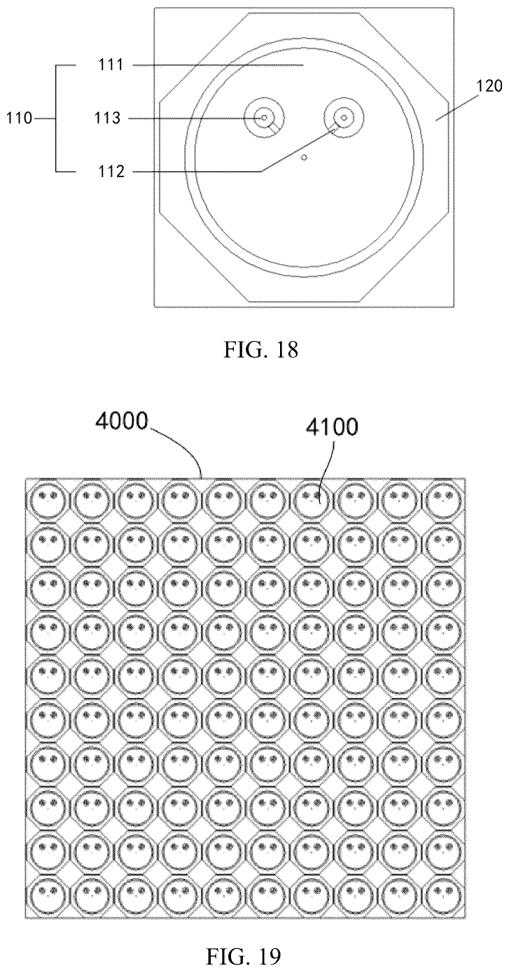

For another example, the reflective unit 110 is circular, and correspondingly, the adjustable electromagnetic array element is a circular-polarization electromagnetic array element. Referring to FIG. 18, the reflective circuit layer 100 as the main body of a reflective part includes a reflective unit 110 and a parasitic unit 120. The reflective unit 110 and the parasitic unit 120 are located in the same layer. The reflective unit 110 includes a first metal sheet 111, two bias voltage sheets 113, and two adjustable elements 4113. The adjustable elements 4113 are located between the first metal sheet 111 and the bias voltage sheets 113. The two adjustable elements 4113 are arranged orthogonal to each other. By controlling electrical parameters of the adjustable elements 4113, phase and magnitude responses of different reflected waves are obtained. The parasitic unit 120 is of an octagonal shape and is nested on an outer side of the reflective unit 110. Optimal coupling is obtained by controlling a distance between an inner side of the parasitic unit 120 and the first metal sheet 111 of the reflective unit 110.

In addition, multi-polarization can be achieved by adjusting the structure of the reflective unit 110, which is not limited in the present disclosure. For example, a triple-polarization electromagnetic array element may be formed by arranging the metal patches of the reflective unit 110 at an angle of 60° relative to each other.

In some embodiments, the adjustable element 112 may be a varactor diode, a Positive-Intrinsic Negative (PIN) diode, a liquid crystal, a Micro-Electro-Mechanical System (MEMS), or the like.

In some embodiments, the adjustable elements 112 may be varactor diodes. By controlling capacitance values of the adjustable elements 112, phase and magnitude responses of different reflected waves can be obtained. The varactor diode is a device on which the voltage can be continuously adjusted. When applied with different voltages, the varactor diode can have N capacitance values, where N is a positive integer greater than or equal to 2. Accordingly, a multi-bit electromagnetic array element can be realized. If the varactor diodes are replaced with PIN diodes, liquid crystals, or other elements, the parasitic meta-surface of the present disclosure has similar functions and effects.

In some embodiments, the technology of the present disclosure is not only suitable for 2+2 (2-bit+dual polarization) RISs, but also has similar effects and effects for 1+1 (1-bit+single polarization), 2+1 (2-bit+single polarization), 1+2 (1-bit+dual polarization), and other multi-bit multi-polarization RISs.

In some embodiments, the adjustable electromagnetic array element is a multi-layer structure, including:
a reflective circuit layer 100, configured for arranging the reflective unit 110;
a first dielectric plate 510, arranged below the reflective circuit layer 100, where at least one metal via electrically connected to the reflective circuit layer 100 is provided in the reflective circuit layer 100; and
a bias circuit layer 200, including a bias line 210 and a bias contact 220 configured for receiving the adjustment signal, where the bias line 210 is electrically connected to the bias contact 220, and the bias contact 220 is electrically connected to the adjustable element 112 through the metal via.

In some embodiments, the adjustable electromagnetic array element further includes:
at least one floor layer, arranged below the bias circuit layer 200 and/or above the bias circuit layer 200, and electrically connected to the reflective unit 110 through a metal via.

In some embodiments, referring to FIG. 3, the adjustable electromagnetic array element is a multi-layer structure, including a reflective circuit layer 100, a first dielectric plate 510, a first floor layer 300, a second dielectric plate 520, a bias circuit layer 200, a third dielectric plate 530, and a second floor layer 400 in sequence from top to bottom. The reflective circuit layer 100 is electrically connected to the first floor layer 300 through a first metal via 610. The reflective circuit layer 100 is electrically connected to the bias circuit layer 200 respectively through two second metal vias 620.

In some embodiments, a bias line 210 in the bias circuit layer 200 is connected to an external interface which is configured for electrically connecting to an external controller to receive a control signal from the external controller.

In some embodiments, the bias circuit layer 200 further includes:
a sheet-like branch 230, connected to the bias contact 220 and configured for forming a filter capacitor with the floor layer.

In some embodiments, referring to FIG. 2 and FIG. 5, the sheet-like branch 230 may be fan-shaped or in other shapes, which is not limited in the present disclosure. The sheet-like branch 230 functions as a short circuit capacitor. That is to say, the sheet-like branch 230 forms a capacitance with the first floor layer 300 or the second floor layer 400 to filter an AC current. In actual operation, part of RF signals (AC current) of the reflective circuit layer 100 may flow to the bias circuit layer 200 through the metal vias and the bias contact 220, and the RF current can be isolated from the DC current (control signal current) by an equivalent capacitance formed between the sheet-like branch 230 and the floor layer. A plurality of sheet-like branches 230 form a parallel capacitor with the floor layer (metallic ground) to cut off the DC current and short-circuit the AC current.

In some embodiments, the bias line 210 travels in a bent manner and is configured for forming a filter inductor. Referring to FIG. 2 and FIG. 5, in the bias circuit layer 200, the bias line 210 is configured as a curved thin line to form the filter inductor, which forms an LC filter circuit with the capacitance formed by the sheet-like branch 230, to better isolate the RF current from the DC current (control signal current). In some embodiments, the filter inductor in the bias circuit layer 200, the capacitance formed by the sheet-like branch 230, and the inductance element 115 arranged in the reflective circuit layer 100 jointly form an LC filter circuit to better isolate the RF current from the DC current (control signal current).

In the embodiment of the present disclosure, the parasitic unit 120 is arranged at the periphery of the reflective unit 110 of the adjustable electromagnetic array element to form a parasitic intelligent surface, and the constitutive parameters of the intelligent surface are changed using the coupling effect between the parasitic unit 120 and the electromagnetic array element, to reduce the reflection loss of the intelligent surface and improve the stability of the phase response of the intelligent surface, thereby overcoming the limitations on the performance of the intelligent surface caused by the array element layout and the dielectric substrate and improving the reliability of the multi-bit multi-polarization RIS scheme.

In addition, the present disclosure further provides an intelligent surface, including a plurality of adjustable electromagnetic array elements described above. The plurality of adjustable electromagnetic array elements of the intelligent surface may be arranged in an M*N matrix or in other manners, which is not limited in the present disclosure. The parasitic unit 120 may be a periodic parasitic unit 120, i.e., the parasitic units 120 of the array elements of the intelligent surface macroscopically exhibit a periodic extension.

The embodiments of the present disclosure will be described in further detail below using three examples.

### Example One

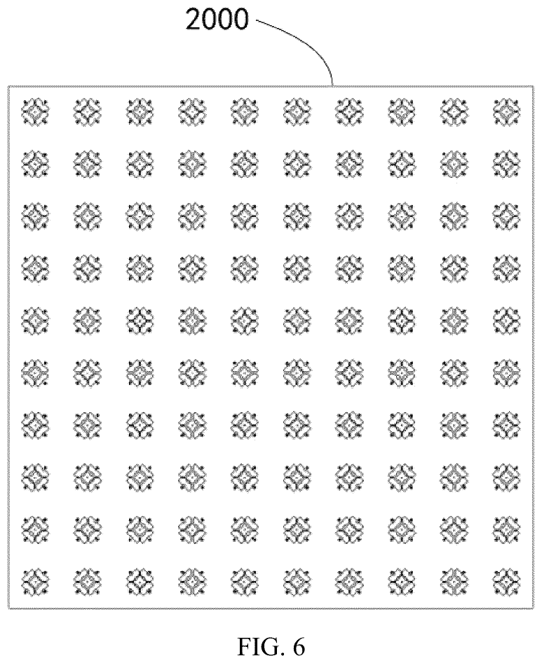

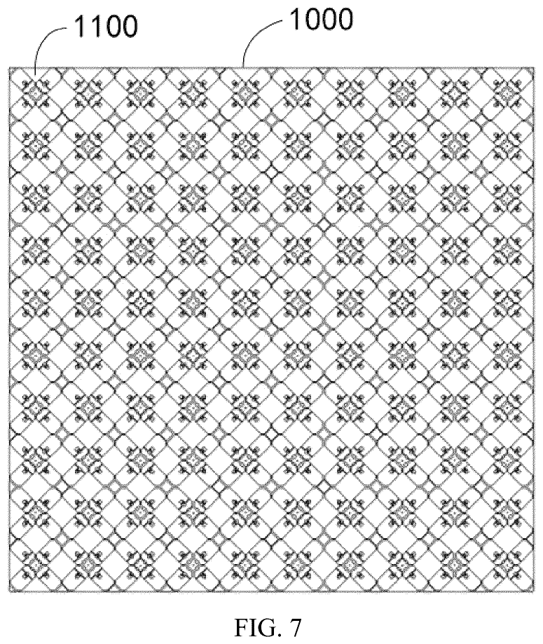

Referring to FIG. 1 to FIG. 7, Example One shows an embodiment (hereinafter referred to as this example) of a 4.9 GHz dynamic 2+2 (2-bit+dual polarization) reflective RIS 1000. Refer to FIG. 6 and FIG. 7. FIG. 6 shows a 10×10 conventional meta-surface 2000 (a meta-surface in the related art), and FIG. 7 shows a 10×10 parasitic meta-surface 1000 provided in this example. It can be seen that the parasitic meta-surface 1000 is constructed by nesting a parasitic unit 120 in the conventional meta-surface 2000. The parasitic meta-surface 1000 includes 10×10 electromagnetic array elements 1100.

The electromagnetic array element 1100 in this example includes two parts: a reflective part as a microstrip structure and a bias part as a stripline structure.

The reflective part includes a reflective circuit layer 100, a first dielectric plate 510, and a first floor layer 300 in sequence from top to bottom. The bias part includes the first floor layer 300, a second dielectric plate 520, a bias circuit layer 200, a third dielectric plate 530, and a second floor layer 400 from top to bottom. The first floor layer 300 is shared by the reflective part and the bias part as an interface between the reflective part and the bias part.

Referring to FIG. 1 and FIG. 4, the reflective circuit layer 100 is a cross-shaped reflector formed by metal patches and includes a reflective unit 110 and a parasitic unit 120.

In this example, referring to FIGS. 1 and 4, the reflective unit 110 of the electromagnetic array element is cross-shaped and includes a first metal sheet 111 of an approximately square shape at the center, a varactor diode (adjustable element 112), four second metal sheets 114, an inductance element 115, and a bias voltage sheet 113 from inside to outside. A first metal via 610 is provided in the middle of the first metal sheet 111 of the approximately square shape. The first metal via 610 is connected to the first floor layer 300 to ensure zero potential. Four second metal sheets 114 are arranged corresponding to the four sides of the square first metal sheet 111 of the approximately square shape and extend outward. The four sides of the first metal sheet 111 of the approximately square shape are respectively connected to the four second metal sheets 114 through four varactor diodes (adjustable elements 112). Four bias voltage sheets 113 are respectively arranged on outer sides of the four second metal sheets 114. The four second metal sheets 114 are respectively connected to the bias voltage sheets 113 through inductance elements 115 to function as series inductors. The bias voltage sheets 113 are connected to the bias circuit layer 200 through second metal vias 620 to provide a forward bias voltage to adjust the capacitance value of the varactor diodes (adjustable elements 112). The inductance element 115 provides an isolation function to prevent an RF current on the reflective unit 110 from flowing into the bias circuit layer 200. The four bias voltage sheets 113 are controlled by two bias lines 210, with two bias voltage sheets 113 being controlled by each bias line 210. Details will be described in the following description of in the bias part.

Four parasitic units 120 are arranged extending in four directions of the cross-shaped reflective unit 110 to be coupled to the reflective unit 110. That is to say, the four parasitic units 120 are arranged at four corners of the reflective circuit layer 100 and are correspondingly coupled to the four second metal sheets 114. Each parasitic unit 120 includes two parts: a triangular parasitic patch 122 and a rectangular parasitic patch 121. The triangular parasitic patch 122 extends outwardly along the rectangular parasitic patch 121 and forms a coupling gap with the rectangular parasitic patch 121. By adjusting the spacing between and the sizes of the rectangular parasitic patch 121 of the parasitic unit 120 and the second metal sheet 114 of the reflective unit 110, optimal proximity coupling can be achieved between two adjacent reflective units 110, thereby changing the wave impedance of the RIS to obtain a low reflection loss and a stable phase response.

A U-shaped groove is etched on a side of the rectangular parasitic patch 121 of the parasitic unit 120 facing the reflective unit 110 to prevent the formation of coupling between the parasitic unit 120 and the bias voltage sheet 113, thereby preventing energy (e.g., energy of the RF current) from bypassing the inductance element 115 to flow into the bias circuit layer 200.

Referring to FIG. 2 and FIG. 5, the bias circuit layer 200 includes two bias lines 210, four bias contacts 220, and four sheet-like branches 230. The sheet-like branches 230 are fan-shaped branches. The four sheet-like branches 230 respectively spread outward from the four bias contacts 220 to form a fan shape. The four sheet-like branches 230 are respectively electrically connected to the four bias contacts 220, the four bias contacts 220 are connected to four second metal vias 620, and respectively form a coupling capacitance with the first floor layer 300 and/or the second floor layer 400, to serve as a parallel short circuit to the RF current. A single bias line 210 connects two bias contacts 220 of single polarization (two bias contacts 220 on a diagonal line) to achieve voltage synchronization control. The bias line 210 is configured as a curved thin line to form the filter inductor, which forms an LC filter circuit with the coupling capacitance formed by the sheet-like branch 230, to better isolate the RF current from the DC current (control signal current). Specifically, the filter inductor in the bias circuit layer 200, the capacitance formed by the sheet-like branch 230, and the inductance element 115 arranged in the reflective circuit layer 100 jointly form an LC filter circuit to better isolate the RF current from the DC current (control signal current).

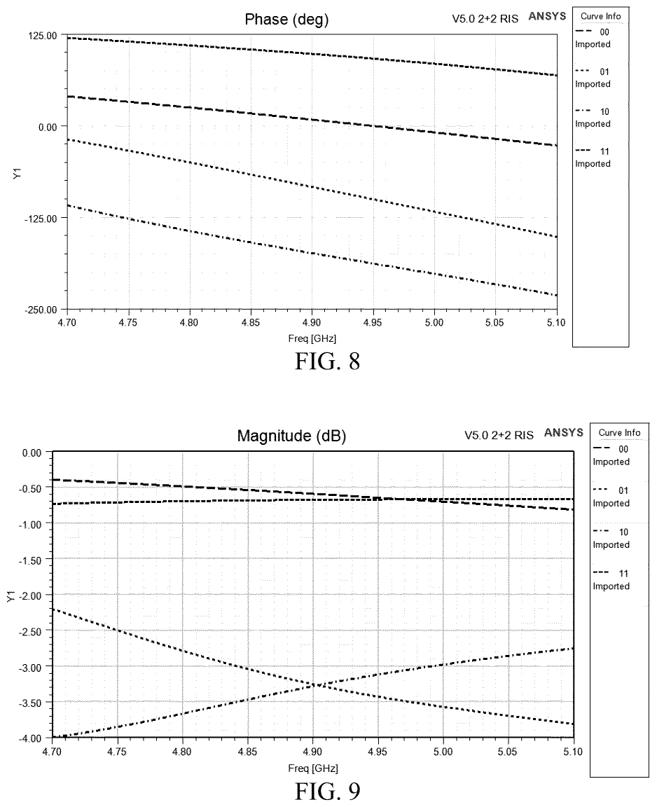

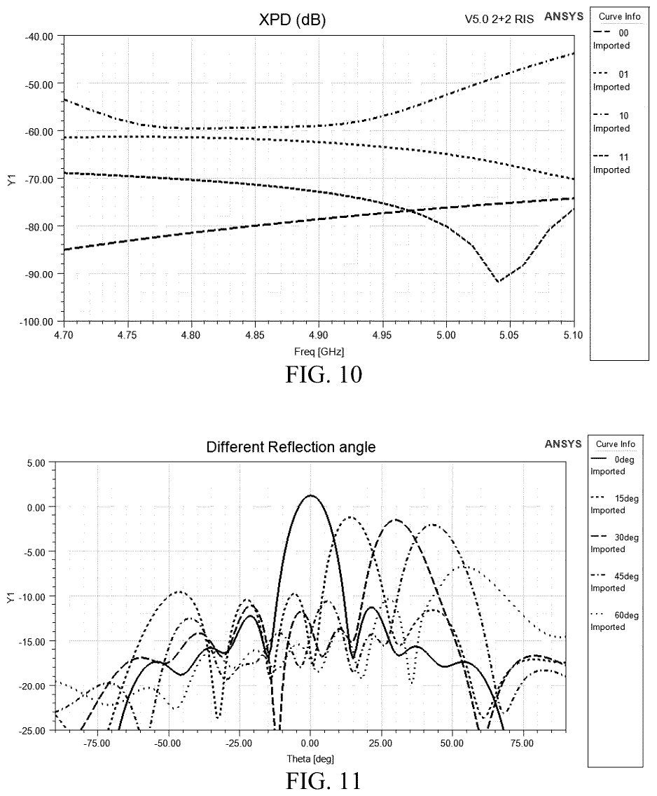

The intelligent surface of this example can obtain satisfactory magnitude and phase response characteristics. FIG. 8, FIG. 9, and FIG. 10 respectively show phase response, magnitude response, and cross-polarization suppression in four states.

FIG. 8 is a phase response waveform. A 2-bit intelligent surface has four states, namely, state 00, state 01, state 10, and state 11, representing different phases of four reflected waves of the intelligent surface, i.e., four different phase states. In the waveform, the horizontal axis represents frequency and the vertical axis represents angle. Ideally, the phase difference between the four phase states is 90°. Referring to FIG. 8, it can be seen from four curves representing the four phase states that at a frequency of 4.9 GHZ, the difference between every two adjacent curves is almost 90°, which is an ideal case.

FIG. 9 is a magnitude response waveform. A 2-bit intelligent surface has four states, namely, state 00, state 01, state 10, and state 11, representing different phases of four reflected waves of the intelligent surface, i.e., four different phase states. In the waveform, the horizontal axis represents frequency and the vertical axis represents reflection loss. In the figure, the four phase states correspond to four curves, representing reflection losses in the four phase states. Generally, the reflection loss should be close to 0 as much as possible. In this example, an ordinary material is used, and even if calculation is performed according to in-band worst values, an ideal reflection loss is achieved. For example, in the figure, the reflection losses corresponding to state 00 and state 01 are both greater than-1 dB, which are very ideal reflection losses; and the reflection losses corresponding to state 01 and state 10 at 4.9 GHz are about-3.3 dB, which are also ideal reflection losses.

FIG. 10 is a ±45° cross-polarization suppression waveform. A 2-bit intelligent surface has four states, namely, state 00, state 01, state 10, and state 11, representing different phases of four reflected waves of the intelligent surface, i.e., four different phase states. In the waveform, the horizontal axis represents frequency and the vertical axis represents a cross-polarization suppression value. In the figure, the four phase states correspond to four curves, representing cross-polarization suppression in the four phase states. It is hoped that two polarizations do not affect each other. The cross-polarization suppression value is an indicator for measuring the degree of influence between the two polarization directions at ±45°. A smaller cross-polarization suppression value indicates a lower degree of influence between the two polarizations. As shown in the figure, the cross-polarization suppression values of the four curves at 4.9 GHz can all be controlled to be −55 dB or below, which is ideal.

This example can support independent electronic control of dual-polarized electromagnetic waves. Table 1 shows a phase difference matrix of dual-polarized reflected waves, where 00, 01, 10, and 11 respectively represent four reflected wave phase states.

TABLE 1
Phase difference matrix of ±45° dual-polarization
independent adjustment (Unit: °)

| +45° | −45° polarization | | | |
|---|---|---|---|---|
| polarization | 00 | 01 | 10 | 11 |
| 00 | 91.3/90.9 | 88.0/89.6 | 87.9/89.6 | 87.5/89.8 |
| 01 | 90.7/88.8 | 94.1/92.6 | 93.8/88.7 | 93.6/89.9 |
| 10 | 89.4/88.9 | 88.7/91.8 | 90.0/90.3 | 88.8/89.0 |
| 11 | 88.6/86.7 | 89.3/93.2 | 88.2/89.3 | 90.1/90.8 |

It can be seen from Table 1 that the four phase states are in two polarization directions at ±45°, and the phase difference between every two phase states is almost 90°, which is an ideal case.

The intelligent surface of this example supports ±60° beam pointing. FIG. 11 shows a directivity pattern of reflected waves at 0°, 15°, 30°, 45°, and 60° when a wave is incident on a 10×10 array at 0° (i.e., incident in a direction perpendicular to the surface of the intelligent surface, where the following angles are measured using 0° as a reference), where the horizontal axis represents the angle of the reflected wave, and the vertical axis represents magnitude (also called wave intensity, which is measured in dB). It can be seen from the figure that the magnitude corresponding to each angle can reach-10 dB or above, and the magnitude response waveform of the reflected wave corresponding to beam pointing at 0° is the best.

As shown in FIG. 11, when all the incident waves are incident at 0°, different beam pointing of reflected waves is realized by adjusting the electromagnetic characteristics of the electromagnetic array elements of each RIS, and the maximum beam pointing is respectively 0°, 15°, 30°, 45°, and 60°.

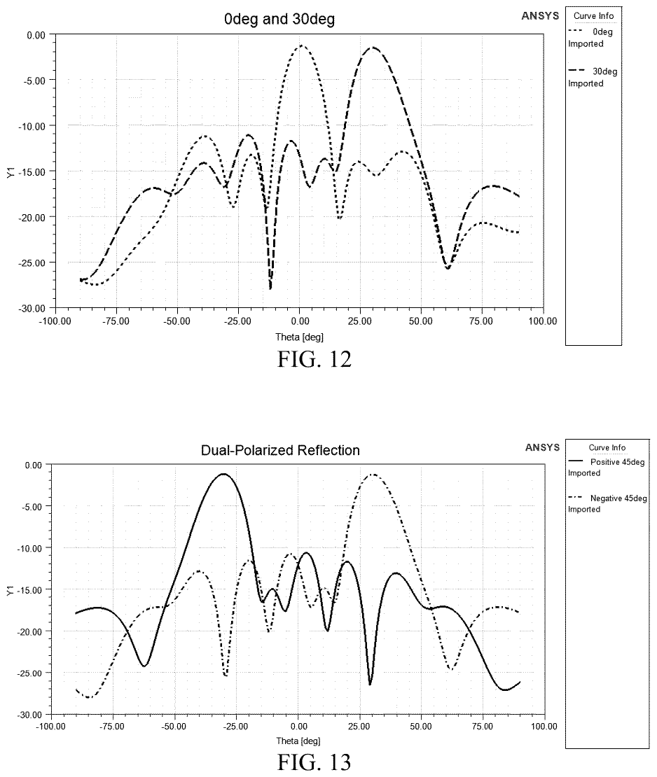

This example supports the beam reciprocity of incident and reflected wave within ±45°. FIG. 12 shows a directivity pattern of reflected waves when waves are incident at 0° and 30° on the 10×10 array in the case of a same codebook, where the horizontal axis represents the angle of the reflected wave, and the vertical axis represents magnitude. It can be seen from the figure that satisfactory magnitude response can be obtained when the waves are incident at 0° and 30°.

This example supports independent beam pointing of dual-polarized reflected waves. FIG. 13 shows a directivity pattern of +45° polarized reflected waves +30° pointing and a directivity pattern of −45° polarized reflected waves −30° pointing of a 10×10 array, where the horizontal axis represents the angle of the reflected wave, and the vertical axis represents magnitude. It can be seen from the figure that satisfactory magnitude response can be obtained for both +45° polarized reflected waves +30° pointing and −45° polarized reflected waves −30° pointing.

### Example Two

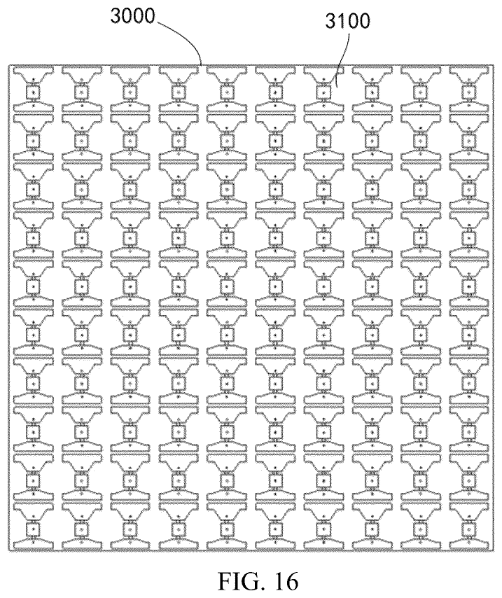

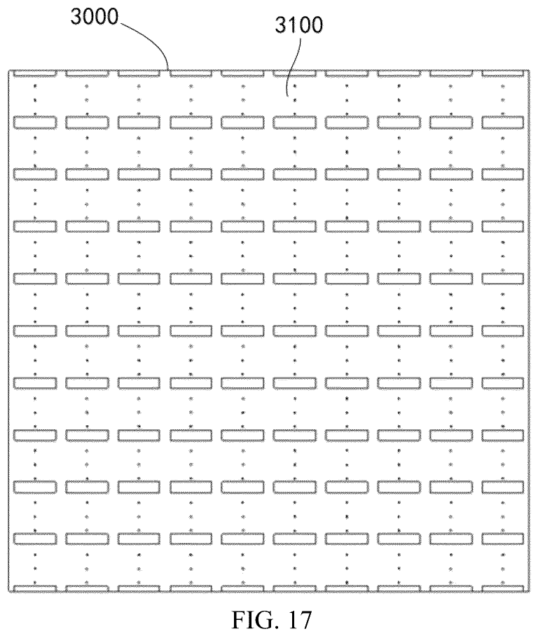

Example Two shows a specific embodiment of a strip-shaped single-polarization dynamic 2+1 (2-bit+single-polarization) reflective RIS 3000. As shown in FIG. 14 to FIG. 17, the electromagnetic array element in this example is a single-polarization electromagnetic array element 3100. FIG. 16 and FIG. 17 are respectively a schematic structural front view and a schematic structural rear view of a 10×10 single-polarization dynamic 2+1 reflective RIS 3000 based on a strip-shaped parasitic meta-surface. The parasitic meta-surface includes 10×10 single-polarization electromagnetic array elements 3100.

The electromagnetic array element in this example is a single-polarization electromagnetic array element 3100. The single-polarization electromagnetic array element 3100 also includes a reflective part and a bias part. A reflective circuit layer, as the main body of the reflective part, includes a reflective unit 110 and a parasitic unit 120. The reflective unit 110 and the parasitic unit 120 are located on two sides of a dielectric plate. That is to way, the parasitic unit 120 is arranged below the reflective unit 110. For example, the parasitic unit 120 may be arranged below the reflective circuit layer where the reflective unit 110 is located, and the dielectric plate is arranged between the parasitic unit 120 and the reflective unit 110. For a specific hierarchical structure, reference may be made to FIG. 3 in Example One. A parasitic circuit layer configured for carrying the parasitic unit 120 may be arranged between the reflective circuit layer and the first floor layer.

The reflective unit 110 includes a first metal sheet 111, adjustable elements, a fourth metal sheet 3112, and a fifth metal sheet 3113. The adjustable elements include a first PIN tube 3114 and a second PIN tube 3115. The first PIN tube 3114 is located between the first metal sheet 111 and the fifth metal sheet 3113. The second PIN tube 3115 is located between the first metal sheet 111 and the fourth metal sheet 3112. By controlling on states of the first PIN tube 3114 and the second PIN tube 3115, different combinations of states of the first metal sheet 111, the fourth metal sheet 3112, and the fifth metal sheet 3113 can be obtained, thereby realizing magnitude and phase responses of different reflected waves. The parasitic unit 120 includes a first parasitic patch 3121 and a second parasitic patch 3122. By adjusting lengths of the first parasitic patch 3121 and the second parasitic patch 3122, the coupling strength between the parasitic unit 120 and the reflective unit 110 is enhanced, thereby reducing the reflection loss of the RIS 3000.

With reference to Example One, the bias part in Example Two may be arranged in a bias circuit layer. The bias part may include two bias lines, two bias contacts, and two fan-shaped branches. The bias lines are correspondingly electrically connected to the bias contacts, and the bias contacts are correspondingly electrically connected to the sector branches. The specific structural design and functional effect are similar to those in Example One, so the details will not be repeated herein.

### Example Three

Example Three shows a specific embodiment of a circular-polarization dynamic 2-bit reflective RIS 4000. As shown in FIG. 18 and FIG. 19, the electromagnetic array element in this example is a circular-polarization electromagnetic array element 4100. FIG. 19 shows a schematic structural diagram of a 10×10 circular-polarization dynamic 2-bit reflective RIS 4000 based on a honeycomb parasitic meta-surface. The parasitic meta-surface includes 10×10 circular-polarization electromagnetic array elements 4100.

The electromagnetic array element in this example is a circular-polarization electromagnetic array element 4100. The circular-polarization electromagnetic array element 4100 also includes a reflective part and a bias part.

Referring to FIG. 18, a reflective circuit layer, as the main body of the reflective part, includes a reflective unit 110 and a parasitic unit 120. The reflective unit 110 and the parasitic unit 120 are located in the same layer as a dielectric plate. The reflective unit 110 includes a first metal sheet 111, two bias voltage sheets 113, and two adjustable elements 112. The first metal sheet 111 is a circular metal patch. The adjustable elements 112 are varactor diodes located between the first metal sheet 111 and the bias voltage sheets 113. The two adjustable elements 112 are arranged orthogonal to each other. By controlling capacitance values of the adjustable elements 112, phase and magnitude responses of different reflected waves are obtained. The parasitic unit 120 is of an octagonal shape and is nested on an outer side of the reflective unit 110. Optimal coupling is obtained by controlling a distance between an inner side of the parasitic unit 120 and the first metal sheet 111 of the reflective unit 110.

For the hierarchical structure of the circular-polarization electromagnetic array element 4100 and the circuit design of the bias part, reference may be made to the corresponding designs in Example One, so the details will not be repeated herein.

In accordance with a first aspect of the present disclosure, an embodiment provides an adjustable electromagnetic array element, including a reflective unit and a parasitic unit. The reflective unit includes at least one reflective metal sheet and at least one adjustable element electrically connected to the reflective metal sheet and configured for adjusting an electromagnetic parameter of the adjustable electromagnetic array element according to an adjustment signal. The parasitic unit is arranged at a periphery of the reflective metal sheet, and is coupled to the reflective metal sheet. In the embodiment of the present disclosure, the parasitic unit is arranged at the periphery of the reflective unit of the adjustable electromagnetic array element to form a parasitic intelligent surface, and the constitutive parameters of the intelligent surface are changed using the coupling effect between the parasitic unit and the electromagnetic array element, to reduce the reflection loss of the intelligent surface and improve the stability of the phase response of the intelligent surface, thereby overcoming the limitations on the performance of the intelligent surface caused by the array element layout and the dielectric substrate, and improving the reliability of the multi-bit multi-polarization RIS scheme. This can effectively improve the performance of the RIS and reduce the manufacturing costs.

It can be understood that the beneficial effects of the second aspect over the related art are the same as the beneficial effects of the first aspect over the related art, and reference may be made to the related description in the first aspect, so the details will not be repeated herein.

Compared with the related art, the embodiments of the present disclosure have the following advantages.
1) The concept of periodic parasitic unit and the technology of constructing a parasitic meta-surface from periodic parasitic units are proposed. In this technology, periodic parasitic units are nested in a conventional reflective meta-surface to form a parasitic meta-surface, thereby changing the matching characteristics between the reflective meta-surface and spatial wave impedance and improving the reflection efficiency and the phase response. This technology can reduce the influence of the size and layout of the electromagnetic scattering units, switching elements, and dielectric substrate on the electromagnetic response characteristics of the meta-surface, improve the reflection efficiency, and expand the phase adjustment range, providing a basis for the development of multi-bit multi-polarization reflective RISs.
2) A dynamic multi-bit multi-polarization reflective meta-surface based on a grid-like parasitic meta-surface is designed. The reflective meta-surface adopts the architectural design of the grid-like parasitic meta-surface, to suppress the current in orthogonal polarization direction while improving the reflection efficiency and expanding the phase adjustment range, thereby avoiding the cross-coupling between multi-polarized reflected waves of the meta-surface and ensuring the independent electrical tuning ability between different polarizations in the multi-polarization RIS.

In the embodiment of the present disclosure, the parasitic unit is arranged at the periphery of the reflective unit of the adjustable electromagnetic array element to form a parasitic intelligent surface, and the constitutive parameters of the intelligent surface are changed using the coupling effect between the parasitic unit and the electromagnetic array element, to reduce the reflection loss of the intelligent surface and improve the stability of the phase response of the intelligent surface, thereby overcoming the limitations on the performance of the intelligent surface caused by the array element layout and the dielectric substrate and improving the reliability of the multi-bit multi-polarization RIS scheme.

Although some implementations of the embodiments of the present disclosure have been described above, the embodiments of the present disclosure are not limited to the implementations described above. Those having ordinary skills in the art can make various equivalent modifications or replacements without departing from the scope of the embodiments of the present disclosure. Such equivalent modifications or replacements fall within the scope defined by the claims of the embodiments of the present disclosure.

1. An adjustable electromagnetic array element, comprising a reflective unit and a parasitic unit, wherein:
the reflective unit comprises:
at least one reflective metal sheet, and at least one adjustable element electrically connected to the reflective metal sheet and configured for adjusting an electromagnetic parameter of the adjustable electromagnetic array element according to an adjustment signal; and
the parasitic unit is arranged at a periphery of the reflective metal sheet, and is coupled to the reflective metal sheet.

2. The adjustable electromagnetic array element of claim 1, wherein:
the parasitic unit is arranged in a same layer as the reflective unit and coupled to the reflective unit; or
the parasitic unit is arranged above the reflective unit and coupled to the reflective unit; or
the parasitic unit is arranged below the reflective unit and coupled to the reflective unit.

3. The adjustable electromagnetic array element of claim 1, wherein a coupling gap is formed between the parasitic unit and the reflective unit, such that the parasitic unit and the reflective unit are coupled through an electric field; or
the parasitic unit and the reflective unit are coupled through an element.

4. The adjustable electromagnetic array element of claim 1, wherein the reflective unit is arranged at a middle position in the adjustable electromagnetic array element, and the parasitic unit is arranged at an outer periphery of the adjustable electromagnetic array element along a polarization direction of the reflective unit, and coupled to the reflective unit.

5. The adjustable electromagnetic array element of claim 1, wherein the reflective metal sheet comprises:
a first metal sheet, configured for electrically connecting to ground; and
a bias voltage sheet, electrically connected to the first metal sheet through the adjustable element and configured for receiving the adjustment signal and transmit the adjustment signal to the adjustable element.

6. The adjustable electromagnetic array element of claim 5, wherein the first metal sheet is a polygonal metal sheet, and the parasitic unit is correspondingly arranged along a side of the polygonal metal sheet, such that a strip-shaped coupling gap is formed between at least one side of the parasitic unit and at least one side of the polygonal metal sheet; or
the first metal sheet is a circular metal sheet, and the parasitic unit is correspondingly arranged along a circumference of the circular metal sheet, such that an annular coupling gap is formed between an edge of the parasitic unit and an edge of the polygonal metal sheet.

7. The adjustable electromagnetic array element of claim 5, wherein a second metal sheet is further arranged between the first metal sheet and the bias voltage sheet, the bias voltage sheet is electrically connected to the second metal sheet, and the second metal sheet is electrically connected to the first metal sheet through the adjustable element; and
the parasitic unit is correspondingly arranged along a side of the second metal sheet, such that a coupling gap is formed between at least one side of the parasitic unit and at least one side of the second metal sheet.

8. The adjustable electromagnetic array element of claim 7, wherein the reflective unit further comprises an inductance element, and the bias voltage sheet is electrically connected to the second metal sheet through the inductance element.

9. The adjustable electromagnetic array element of claim 5, wherein in response to the parasitic unit and the reflective unit being arranged in the same layer, the parasitic unit is provided with a U-shaped groove configured for accommodating the bias voltage sheet at a position corresponding to the bias voltage sheet.

10. The adjustable electromagnetic array element of claim 1, wherein:
the reflective unit is linear, and correspondingly, the adjustable electromagnetic array element is a single-polarization electromagnetic array element; or
the reflective unit is cross-shaped, and correspondingly, the adjustable electromagnetic array element is a dual-polarization electromagnetic array element; or
the reflective unit is circular, and correspondingly, the adjustable electromagnetic array element is a circular-polarization electromagnetic array element.

11. The adjustable electromagnetic array element of claim 1, wherein the adjustable element is a varactor diode, a Positive-Intrinsic Negative (PIN) diode, or a liquid crystal.

12. The adjustable electromagnetic array element of claim 1, wherein the adjustable electromagnetic array element is a multi-layer structure comprising:
a reflective circuit layer, configured for arranging the reflective unit;
a first dielectric plate, arranged below the reflective circuit layer, wherein at least one metal via electrically connected to the reflective circuit layer is provided in the reflective circuit layer; and
a bias circuit layer, comprising a bias line and a bias contact configured for receiving the adjustment signal, wherein the bias line is electrically connected to the bias contact, and the bias contact is electrically connected to the adjustable element through the metal via.

13. The adjustable electromagnetic array element of claim 12, further comprising:
at least one floor layer, arranged below the bias circuit layer and/or above the bias circuit layer, and electrically connected to the reflective unit through a metal via.

14. The adjustable electromagnetic array element of claim 13, wherein the bias circuit layer further comprises:
a sheet-like branch, connected to the bias contact and configured for forming a filter capacitor with the at least one floor layer.

15. The adjustable electromagnetic array element of claim 12, wherein the bias line travels in a bent manner and is configured for forming a filter inductor.

16. An intelligent surface, comprising a plurality of adjustable electromagnetic array elements, the adjustable electromagnetic array element comprising a reflective unit and a parasitic unit, wherein:
the reflective unit comprises:
at least one reflective metal sheet, and
at least one adjustable element electrically connected to the reflective metal sheet and configured for adjusting an electromagnetic parameter of the adjustable electromagnetic array element according to an adjustment signal; and
the parasitic unit is arranged at a periphery of the reflective metal sheet, and is coupled to the reflective metal sheet.

17. The adjustable electromagnetic array element of claim 2, wherein the reflective metal sheet comprises:
a first metal sheet, configured for electrically connecting to ground; and
a bias voltage sheet, electrically connected to the first metal sheet through the adjustable element and configured for receiving the adjustment signal and transmit the adjustment signal to the adjustable element.

18. The adjustable electromagnetic array element of claim 3, wherein the reflective metal sheet comprises:
a first metal sheet, configured for electrically connecting to ground; and
a bias voltage sheet, electrically connected to the first metal sheet through the adjustable element and configured for receiving the adjustment signal and transmit the adjustment signal to the adjustable element.

19. The adjustable electromagnetic array element of claim 4, wherein the reflective metal sheet comprises:
a first metal sheet, configured for electrically connecting to ground; and
a bias voltage sheet, electrically connected to the first metal sheet through the adjustable element and configured for receiving the adjustment signal and transmit the adjustment signal to the adjustable element.

20. The adjustable electromagnetic array element of claim 2, wherein:
the reflective unit is linear, and correspondingly, the adjustable electromagnetic array element is a single-polarization electromagnetic array element; or
the reflective unit is cross-shaped, and correspondingly, the adjustable electromagnetic array element is a dual-polarization electromagnetic array element; or
the reflective unit is circular, and correspondingly, the adjustable electromagnetic array element is a circular-polarization electromagnetic array element.
